(19) United States
(12) Patent Application Publication
(10) Pub. No.: US 2019/0207525 A1
(43) Pub. Date: Jul. 4, 2019

(54) SYNCHRONOUS RECTIFICATION CIRCUIT AND TECHNIQUE FOR SYNCHRONOUS RECTIFICATION

(71) Applicant: ESAB AB, Gothenburg (SE)

(72) Inventor: Andreas SVENSSON, Tibro (SE)

(21) Appl. No.: 16/284,204

(22) Filed: Feb. 25, 2019

Related U.S. Application Data
(63) Continuation of application No. PCT/IB2016/055082, filed on Aug. 25, 2016.

(51) Int. Cl. H02M 3/335; H02M 7/219; B23K 9/10; B23K 9/09

(52) U.S. Cl. CPC H02M 3/33584; H02M 7/219; H02M 2001/0048; B23K 9/093; B23K 9/1012

(57) ABSTRACT

A power supply to provide welding power. The power supply may include a dc source providing a direct current (DC) voltage input; a bridge circuit comprising a first plurality of switches, the bridge circuit being disposed on a primary side of the power supply and being coupled to receive the DC voltage input, and to output a primary voltage signal; a transformer coupled to the bridge circuit to transform the primary voltage signal to a secondary voltage signal; a synchronous rectification circuit to receive the secondary voltage signal and generate a welding signal, the synchronous rectification circuit comprising a second plurality of switches; and a controller coupled to the bridge circuit and synchronous rectification circuit, to coordinate operation of the plurality of primary switches with operation of the plurality of secondary switches.

### CROSS-REFERENCE TO RELATED APPLICATIONS

This application is a continuation of International Application No. PCT/IB2016/055082, filed on Aug. 25, 2016, the entire contents of which is hereby incorporated by reference.

### TECHNICAL FIELD

The present embodiments are related to power supplies for welding type power, that is, power generally used for welding, cutting, or heating.

### BACKGROUND

For welding apparatus, there is an ongoing industry demand for lighter, more cost effective and energy efficient welding machines. One manner of improving welding apparatus is to provide a more efficient power supply, since the power supply can take up a significant cost and weight of the whole welding apparatus. Improvements in efficiency may also decrease demand for cooling, may reduce converter size and decrease overall costs.

In some known direct current (DC) welding regular rectifiers may be employed. Power loss at the secondary side is then associated with the band gap voltage of components used in such a solution. This limitation is inherent in the semiconductor technology by itself, so that the power loss in combination with large currents will stay the same, resulting in no improvement in efficiency no matter what type of diode is used. Additionally, at low load conditions the power supply will enter discontinuous mode, forcing the output impedance of the system to be high. This increased impedance may impede agile load regulation, which regulation is central in a welding process.

It is with respect to these and other considerations that the present disclosure is provided.

### BRIEF SUMMARY

In one embodiment, a power supply to provide welding power may include a dc source providing a direct current (DC) voltage input. The power supply may further include a bridge circuit comprising a plurality of primary switches, the bridge circuit being disposed on a primary side of the power supply and being coupled to receive the DC voltage input, and to output a primary voltage signal; a transformer coupled to the bridge circuit to transform the primary voltage signal to a secondary voltage signal; a synchronous rectification circuit to receive the secondary voltage signal and generate a welding signal, the synchronous rectification circuit comprising a plurality of secondary switches; and a controller coupled to the bridge circuit and synchronous rectification circuit to coordinate operation of the plurality of primary switches with operation of the plurality of secondary switches.

In another embodiment, a method of providing welding power in a welder, may include receiving a DC voltage at a bridge circuit, the bridge circuit comprising a plurality of primary switches at a primary side of the welder; generating, using the bridge circuit, a primary voltage signal based upon a DC voltage; transforming the primary voltage signal to a secondary voltage signal on a secondary side of the power supply via a transformer; and rectifying the secondary voltage signal using a synchronous rectification circuit, the synchronous rectification circuit comprising a plurality of secondary switches, wherein the rectifying comprises coordinating operation of the plurality of primary switches with operation of the plurality of secondary switches.

### DESCRIPTION OF FIGURES

FIG. 1 shows in block form a welding apparatus according to embodiments of the disclosure.

FIG. 2 shows a portion of circuitry of a welder according to an embodiment of the disclosure.

FIG. 3 shows an exemplary signal diagram for operating a welder according to embodiments of the disclosure.

### DESCRIPTION OF EMBODIMENTS

The present embodiments provide improvements over conventional apparatus used to generate power for welding. In various embodiments, a welding apparatus is provided having improved rectification in a power supply. In various embodiments, by replacing a set of diodes with an active rectifier assembly that can conduct in the third quadrant of current-voltage plane, and having a resistive function of voltage drop, two major issues can be eliminated: the intrinsic voltage drop that is a function of band gap voltage and the fluctuation in output impedance due to transition between discontinuous to continuous mode operations. In principle, this arrangement may eliminate rectification loss, and provide better control of a welding process due to the fact that the welding system may now run with a low output impedance.

According to embodiments of the disclosure welding apparatus are provided with synchronous rectification circuitry and techniques. As detailed in the embodiments disclosed below, synchronous rectification may involve, among other features, the generation of predictable dead times when rectifiers are to be ON or OFF. Additionally, for four quadrant rectifiers, the possibility of conduction in the third quadrant of the current-voltage plane may be handled and controlled in a manner to avoid avalanche breakdown when conducting against an inductive load. Therefore, providing synchronous rectification may entail a highly sophisticated control system for conduction timing, and also special techniques to handle such a system. In particular embodiments, this rectification may be implemented by virtue of available field programmable gate array (FPGA) and digital signal processor (DSP) approaches, where control can be logically implemented in software, for example.

In various embodiments of the disclosure, a DC source welding apparatus may be implemented using a DC-DC converter architecture including a bridge circuit on the primary side, a transformer and synchronous rectification circuit on the secondary side. The welding apparatus may further include a controller coupled to the bridge circuit and synchronous rectification circuit to coordinate operation of these components in an advantageous manner.

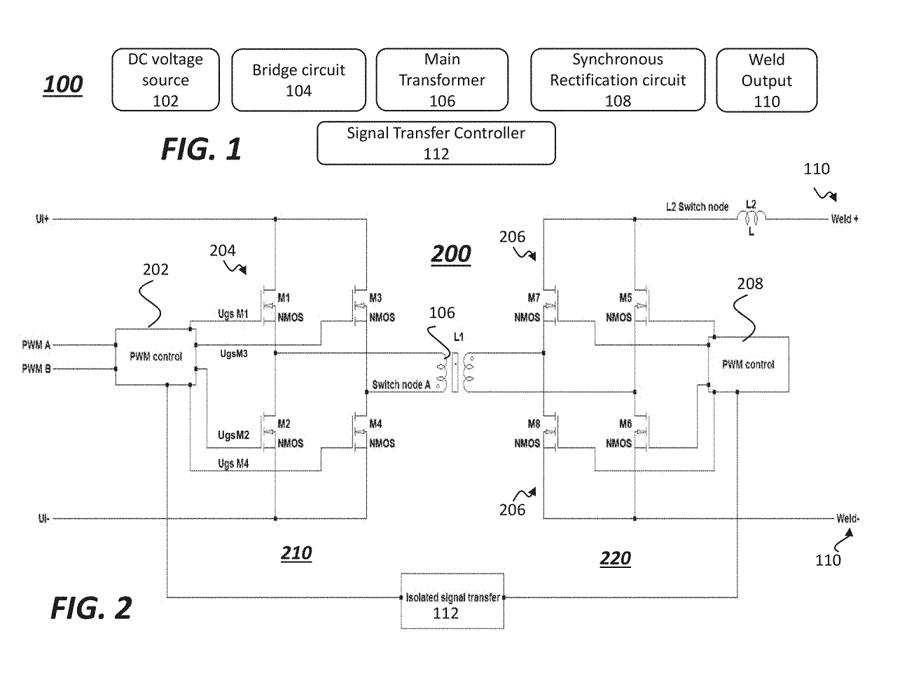

Turning now to FIG. 1 there is shown in block form a welding apparatus 100 according to embodiments of the disclosure. The welding apparatus 100 may include a DC voltage source 102, a bridge circuit 104, a main transformer 106, a synchronous rectification circuit 108, a weld output 110, and a signal transfer controller 112. In operation, a DC voltage may be provided by the DC voltage source 102 to the bridge circuit 104.

According to various embodiments the bridge circuit 104 includes a first plurality of switches that output a primary voltage signal to the main transformer 106, where the main transformer 106 provides the galvanic isolation between a primary side and a secondary side of the welding apparatus 100. In particular, the main transformer 106 may receive a primary voltage signal output by the bridge circuit having a given voltage amplitude. The main transformer may output a secondary voltage signal where the secondary voltage signal is received by the synchronous rectification circuit 108. The secondary voltage signal may represent, for example, a smaller voltage amplitude than the primary voltage signal.

In accordance with various embodiments of the disclosure, rather than passive rectification, the synchronous rectification circuit 108 may provide active rectification that provides the aforementioned advantages, including elimination of voltage drop and output impedance fluctuations.

Turning now to FIG. 2, there is shown a portion of circuitry of a welder, referred to herein as welder 200, where the welder 200 may be a variant of the welding apparatus 100. In brief, the welder 200 includes a DC voltage source shown as the pair of inputs, U+ and U−, and a full bridge 204, arranged to receive the DC voltage from the DC voltage source. The full bridge 204 may convert the DC voltage to a primary voltage signal that represents an AC voltage signal for output through a main transformer 106. The AC voltage signal may be rectified by a synchronous rectification circuit 206 and transmitted as DC power to the weld output 110.

As shown in FIG. 2, the full bridge 204 may include a plurality of primary switches, shown as M1-M4, where the primary switches may be semiconductor switches such as metal oxide field effect transistors (MOSFETS) in some embodiments. The primary switches are disposed on the primary side 210 of the welder 200 and may operate in pairs according to known principles of operation of a full bridge circuit. In particular, the full bridge 204 may include a first pair of primary switches, such as M1 and M4, where the first pair of primary switches operate in unison with one another; and may include a second pair of primary switches, such as M2 and M3, where the second pair of primary switches also operate in unison with one another. In known full bridge arrangements the primary switch voltage does not exceed the input voltage to the full bridge. When one of the primary switches is active for a full-bridge arrangement, the switches are activated as diagonal pairs. When a pair of diagonal switches is active, the voltage across the primary winding of the main transformer 106 is the full value of the input voltage. Therefore, for a given power, the primary current will be half as much for the full-bridge as compared to a known half-bridge arrangement. The reduced current enables a high degree of efficiency especially at high load currents.

Advantageously, the synchronous rectification circuit 206 may also include a plurality of secondary switches that are actively controlled. In the particular embodiment shown in FIG. 2, synchronous rectification circuit 206 may include a full bridge architecture, where the synchronous rectification circuit comprises a first pair of secondary switches (meaning switches disposed on the secondary side 220 of the welder 200) and a second pair of secondary switches, in this case shown as M7 and M6, and M5 and M8, respectively. The first pair of secondary switches may also operate in unison with one another, and the second pair of secondary switches additionally may operate in unison with one another.

As suggested by FIG. 2, in various embodiments the switches M1-M8 may be N-type MOSFETs. Notably, in other embodiments, different combinations of switches may be used. For example, MOSFETs may be advantageously employed for switches M5-M8 on the secondary side as opposed to insulated gate bipolar transistors (IGBTs), since MOSFETs do not incur a voltage drop of approximately 2V that takes place in an IGBT when fully saturated. Notably, on the primary side, the operating voltage may be much greater and therefore use of IGBTs for switches M1-M4 may provide advantages in a high current and high voltage combination. Additionally, other known elements that act as true switches may be employed as the switches in other embodiments.

Because the synchronous rectification circuit 206 does not involve the use of just diodes (passive rectification) for rectification, for proper active rectification to take place, signals may be scheduled to coordinate operation between the switches on the primary side 210 of the welder 200 and switches on the secondary side 220 of the welder 200. In particular, the full bridge 204, by operation of the switches M1-M4, may generate a primary voltage signal that is received by the main transformer 106, where the main transformer 106 transforms the primary voltage signal to a secondary voltage signal that varies with time. Because the secondary voltage signal received by the synchronous rectification circuit 206 may vary with time according to duty cycles of the switches M1-M4, as detailed below, the synchronous rectification circuit may be scheduled to time the operation of switches (M5-M8) with respect to operation of switches M1-M4. This timing allows the synchronous rectification circuit 206 to rectify the secondary voltage signal and to generate a welding signal in a manner that prevents short circuiting between the primary side 210 and secondary side 220 of welder 200, as well as to prevent freewheeling current from passing through main transformer 106.

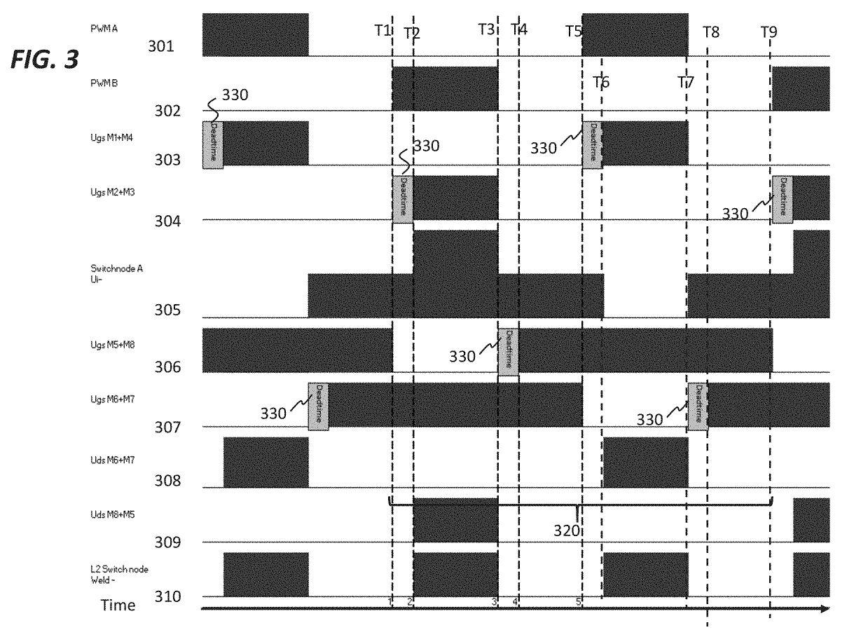

Turning now to FIG. 3, there is shown a signal diagram where various signals of a welding circuit are shown as a function of time according to embodiments of the disclosure. For example, the signal diagram of FIG. 3 may embody operation of the welder 200 of FIG. 2. Line 301 (PWM A) and line 302 (PWM B) represent the duty cycle from a pulse width modulator (PWM) that may be input to the PWM control component 202, as well as PWM control component 208, shown in FIG. 2. Line 303 and line 304, Ugs M1+M4 and Ugs M2+M3, respectively, represent the gate drive signals that are sent to the various switches of the full bridge 204, including corresponding dead times. Referring also to FIG. 2, for example, there is shown a signal UgsM1 directed to M1, a signal UgsM4 directed to M4, signal UgsM2 directed to M2, a signal UgsM3 directed to M3. As shown in FIG. 3, the signals UgsM1 and UgsM4 may be coordinated wherein the signals go high or low in concert with one another. Similarly, the signals UgsM2 and UgsM3 may be coordinated wherein the signals go high or low in concert with one another.

Line 305 represents the switch node of the main transformer 106 (also labeled L1 in FIG. 2). The three typical voltage steps when the primary switches the voltage over the primary winding are shown.

Line 306 and line 307 show the gate drive signals UgsM8+UgsM5 and UgsM6+UgsM7 for the switches M8+M5 and M6+M7, respectively, of the synchronous rectification circuit 206. Signals shown in line 306 and line 307 include corresponding dead times to prevent same time conduction with the primary side. As shown in FIG. 3, the signals UgsM8 and UgsM5 may be coordinated wherein the signals go high or low in concert with one another. Similarly, the signals UgsM6 and UgsM7 may be coordinated wherein the signals go high or low in concert with one another.

Line 308 and line 309 represent the voltage over drain to source for the pair of switches M6+M7, Uds M6+M7, and the voltage over drain to source for the pair of switches M5+M8, Uds M5+M8, respectively. Again, the timing of voltage over drain to source of switch M6 is the same as the timing of voltage over drain to source of switch M7, and the timing of voltage over drain to source of switch M5 is the same as the timing of voltage over drain to source of switch M8. Finally, and referring again to FIG. 2, line 310 represents the voltage over output choke L2 as a function of time.

Notably, in the discussion to follow, the relative timing of various signals in FIG. 3 may be coordinated by components of a welder 200, which coordination may be implemented in hardware, software, or a combination of hardware and software. In various embodiments, PWM signals and the PWM control component 202, PWM control component 208, as well as signal transfer controller 112 may be implemented in a common PWM engine, including a DSP, FPGA, or dedicated application specific integrated circuit (ASIC).

As shown in FIG. 3, at time T1, the signal on line 302, PWM B, goes high to generate a voltage-time area (integral) over the main transformer 106. Additionally, at T1, the gate signal to M8+M5, UgsM5+M8, goes from a high state to a low state. This transition to a low state is also coordinated to initiate a delay interval 330, where a signal to turn on the gates of the switches M2+M3 is delayed by a dead time. This delay interval 330 is provided so the switches M8+M5 are completely off before the switches M2+M3 are conducting, in order to prevent a short circuit conduction between the primary and secondary side of the welder 200. At the same time (T1) the switches M6+M7 are still in a conducting state, as indicated by UgsM6+M7, waiting for the primary side to start conducting.

At time T2, Ugs M2+M3 goes from a low state to a high state, and the switches M2 and M3 begin conducting. Also at T2, the drain to source voltage over M8+M5, Uds M8+M5, goes from a low state to a high state, and applies a voltage-time area over L2. At time T2, M6+M7 are still in a conducting state, and a current can accordingly pass into the output choke L2. At the primary side 210 of welder 200, the switch node goes to the input voltage and the voltage-time area is applied over the primary side of main transformer 106.

At the time T3, enough voltage-time area has been applied to satisfy the energy balance in the power train of welder 200, and the PWM B signal transitions from a high state to a low state, as shown. Without delay, the Ugs M2+M3 transitions from a high state to low state, turning off the switches, M2 and M3. At the time T3, the switches M5 and M8 are still in an OFF state, and the turning of these switches to an ON state is delayed by a dead time represented by another delay interval 330, as shown on line 306, Ugs M5+M8. This delay interval 330 is established to ensure that M2+M3 switches on the primary side 210 have stopped conducting before the switches M5+M8 on the secondary side 220 begin conducting, ensuring that a short circuit conduction is avoided between primary side 210 and secondary side 220.

At time T4, the Ugs M5+M8 transitions from a low state to a high state, turning on the switches M5+M8. At the same time Ugs M6+M7 are still in a high state. Accordingly, all the MOSFETs of the synchronous rectification circuit 206, that is, switches M5-M8, are conducting at the same time. This simultaneous conduction in all the switches of the synchronous rectification circuit 206 avoids freewheeling current from passing through the secondary winding of the main transformer 106, and thus avoids unnecessary heating of the secondary winding.

At time T5, a new portion of the cycle starts with PWM A as leading edge. At this time, the signal on line 301, PWM A, goes high to generate a voltage-time area over the main transformer 106. Additionally, at T5, the gate signal to M6+M7, UgsM6+M7, goes from a high state to a low state. This transition to a low state also is coordinated to initiate a delay interval 330, where a signal to turn on the gates of the switches M1+M4 is delayed by a dead time. This delay interval 330 is provided so the switches M6+M7 are completely off before the switches M1+M4 are conducting, in order to prevent a short circuit conduction between the primary and secondary side of the welder 200. At the same time (T5) the switches M5+M8 are still in a conducting state, as indicated by UgsM5+M8, waiting for the primary side to start conducting.

At time T6, Ugs M1+M4 goes from a low state to a high state, and the switches M1 and M4 begin conducting. Also at T6, the drain to source voltage over M6+M7, Uds M6+M7, goes from a low state to a high state, and applies a voltage-time area over L2. At time T6, M5+M8 are still in a conducting state, and a current can go into the output choke L2. At the primary side 210 of welder 200, the switch node goes to the input voltage and the voltage-time area is applied over the primary side of main transformer 106.

At the time T7, enough voltage-time area has been applied to satisfy the energy balance in the power train of welder 200, and the PWM B signal transitions from a high state to a low state, as shown. Without delay, the Ugs M1+M4 transitions from a high state to low state, turning off the switches, M1 and M4. At the time T7, the switches M6 and M7 are still in an OFF state, and the turning on of these switches is delayed by a dead time indicated by a delay interval 330 as shown on line 307, Ugs M6+M7. This delay interval 330 is established to ensure that M1+M4 switches on the primary side 210 have stopped conducting before the switches M6+M7 on the secondary side 220 begin conducting, ensuring that a short circuit conduction is avoided between primary side 210 and secondary side 220.

At time T8, the Ugs M6+M7 transitions from a low state to a high state, turning on the switches M6+M7. At the same time Ugs M5+M8 are still in a high state. Accordingly, all the MOSFETs, that is, switches M5-M8, are conducting at the same time. This simultaneous conduction in all the switches of the synchronous rectification circuit 206 avoids freewheeling current from passing through the secondary winding of the main transformer 106, and thus avoids unnecessary heating of the secondary winding. At time T9, a cycle 320 is complete and a new cycle, also shown as cycle 320, starts over again with PWM B as leading edge as described above.

As shown in FIG. 3, the periods where current is applied over the output choke L2 correspond to the periods where Uds M6+M7 is high or where UdsM5+M8 is high. The duration of these periods is determined by the duration of the PWMA signal and PWMB signal, and additionally the duration of the delay intervals 330. Notably, the various delay intervals need not have the same duration. The exact duration of the delay intervals 330 may be determined according to the properties of the semiconductor switches to ensure a given pair of switches on a first side of the welder that is turned off at a given first instance is completely in an OFF state at a second instance where another set of switches on the other side of the welder is to be turned on.

Using the above-described procedures, the synchronous rectification may be performed over a range of different conditions according to different embodiments. In some implementations, the various dead times (delay intervals) may be preset in hardware so any unwanted same time conduction in any imaginable condition is avoided. In other implementations, a control component, such as a digital pulse width modulator (DPWM), DSP or FPGA may be employed to set delay intervals that are controlled by present working conditions of a welder. While sufficient duration of a delay interval may ensure the avoidance of same time conduction between, for example, switches M2 and M3 on the one hand and switches M5 and M8 on the other hand, the delay interval may also need to be limited in duration to avoid forcing the current to be conducted in the parasitic body diode (at the secondary freewheeling time). If in such a circumstance the diode saturates, the Trr of the diode might emit more losses than the conduction losses of the MOSFET, where Trr is the reverse recovery time. As is known, the body diode of a MOSFET is a regular silicon diode. When the voltage is reversed over the diode after the diode has conducted in a forward directions, the diode will conduct current in wrong direction for a short time measured in the term “Trr. Modern MOSFETs exhibit a conduction time in the range of 50 ns-150 ns, but a problem is that the “Trr” time will actually act as a short circuit until a transitions is complete. The length of Trr is dependent on how much current the diode has conducted and will reach a maximum stated by the datasheet of the current MOSFET or diode. This fact is troublesome in all hard switched topologies when the voltage abruptly reverses. Prior efforts have attempted to make the Trr as soft and small as possible, with the disadvantage that limiting Trr may cause performance to be sacrificed in other areas. When using synchronous rectification, a useful approach is to match the dead times so minimum conduction time in the diode is achieved. For silicon diodes, an underlying culprit is the silicon diode's minority carriers that need to be reversed when the voltage is reversed after a conduction time.

In view of the above, the setting of delay intervals in accordance with embodiments of the disclosure may balance the time needed to avoid same time conduction while still preventing unnecessary losses. Notably, under idling conditions or at low load conditions of a welder, the delay interval needs to be larger, and to be gradually reduced when the load increases. In some embodiments, the delay interval may be different in the primary side switches as compared to the delay interval in the secondary side switches. In particular embodiments, up to four different delay intervals may be employed to accommodate different dead times that are imbedded in gate drivers and different types of MOSFETs that may be used in the same power train of a welder.

In various embodiments, the synchronous rectification as described with respect to the above figures may be applied over a range of physical size and switching periods. For example, a power train operating at just 60 Hz yields a switching period in the millisecond (ms) range. In other embodiments for power inverters operating in the range of 50 kHz, the switching period is approximately 20 μs. This period yields a maximum duty cycle of 10 μs. To avoid cross conduction in the bridge at the primary side a common practice is to restrict the maximum duty cycle to 80-90% of that value, yielding an 8 μs-9 μs duty cycle. For such short duty cycles, MOSFETs may be the most appropriate switches, since present day MOSFETs may have use up to 200 ns dead time, as opposed to 1 μs to 2 μs for IGBTs.

While the aforementioned embodiments have focused on configurations where a full bridge is employed on the primary side, in other embodiments, synchronous rectification may apply for half-bridge topologies as well as other buck converter topologies including forward, two transistor forward, and buck-boost converters, using the same or similar principles as set forth herein.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Thus, the claims set forth below should be construed in view of the full breadth and spirit of the present disclosure as described herein.

What is claimed is:

1. A power supply to provide welding power, comprising:
a dc source providing a direct current (DC) voltage input;
a bridge circuit comprising a plurality of primary switches, the bridge circuit being disposed on a primary side of the power supply and being coupled to receive the DC voltage input, and to output a primary voltage signal;
a transformer coupled to the bridge circuit to transform the primary voltage signal to a secondary voltage signal;
a synchronous rectification circuit to receive the secondary voltage signal and generate a welding signal, the synchronous rectification circuit comprising a plurality of secondary switches; and
a controller coupled to the bridge circuit and synchronous rectification circuit to coordinate operation of the plurality of primary switches with operation of the plurality of secondary switches.

2. The power supply of claim 1, wherein a first pair of secondary switches of the synchronous rectification circuit are placed in an OFF state before a first pair of primary switches of the bridge circuit are placed in a conducting state.

3. The power supply of claim 2, wherein the bridge circuit further comprises a second pair of primary switches, the first pair of primary switches operating in unison with one another, and the second pair of primary switches operating in unison with one another.

4. The power supply of claim 3, wherein the synchronous rectification circuit comprises a second pair of secondary switches, the first pair of secondary switches operating in unison with one another, and the second pair of secondary switches operating in unison with one another.

5. The power supply of claim 4, wherein the first pair of secondary switches is in an ON state when the first pair of primary switches is in an ON state, and wherein the second pair of secondary switches is in an ON state when the second pair of primary switches is in an ON state.

6. The power supply of claim 4, wherein the second pair of secondary switches of the synchronous rectification circuit are placed in an OFF state before the second pair of primary switches of the bridge circuit are in a conducting state.

7. The power supply of claim 1, wherein the synchronous rectification circuit comprises a plurality of semiconductor switches.

8. The power supply of claim 7, wherein the plurality of semiconductor switches comprise a plurality of metal oxide field effect transistors.

9. A method of providing welding power in a welder, comprising:
receiving a DC voltage at a bridge circuit, the bridge circuit comprising a plurality of primary switches at a primary side of the welder;
generating, using the bridge circuit, a primary voltage signal based upon a DC voltage;
transforming the primary voltage signal to a secondary voltage signal on a secondary side of the power supply via a transformer; and
rectifying the secondary voltage signal using a synchronous rectification circuit, the synchronous rectification circuit comprising a plurality of secondary switches,
wherein the rectifying comprises coordinating operation of the plurality of primary switches with operation of the plurality of secondary switches.

10. The method of claim 9, further comprising placing a first pair of secondary switches of the synchronous rectification circuit in an OFF state before a first pair of primary switches of the bridge circuit are placed in a conducting state.

11. The method of claim 9, wherein the bridge circuit comprises a first pair of primary switches and a second pair of primary switches, the first pair of primary switches operating in unison with one another, and the second pair of primary switches operating in unison with one another.

12. The method of claim 11, wherein the synchronous rectification circuit comprises a first pair of secondary switches and a second pair of secondary switches, the first pair of secondary switches operating in unison with one another, and the second pair of secondary switches operating in unison with one another.

13. The method of claim 12, further comprising maintaining the first pair of primary switches in an ON state when the first pair of secondary switches is in an ON state, and maintaining the second pair of primary switches in an ON state when the second pair of secondary switches is in an ON state.

14. The method of claim 12, further comprising placing the second pair of secondary switches of the synchronous rectification circuit in an OFF state before the second pair of primary switches of the bridge circuit are placed in a conducting state.
